(19) United States
(12) Patent Application Publication
(10) Pub. No.: US 2010/0170105 A1
(43) Pub. Date: Jul. 8, 2010

(54) Grain dryer

(76) Inventor: David W. Burns, Prairie City, IA (US)

Correspondence Address: BRETT J. TROUT, PC, 516 WALNUT, DES MOINES, IA, 50309, US

(21) Appl. No.: 12/319,482

(22) Filed: Jan. 8, 2009

(51) Int. Cl. F26B 3/08

(52) U.S. Cl. 34/475; 34/68; 34/235

(57) ABSTRACT

A grain drying system utilizing a geothermal loop to remove heat from the ground, and a heat pump to transfer the ground heat to air which is provided over grain to assist in the drying. The system is provided with a telescoping duct to allow more or less ambient air into the system to assist in the drying process, depending upon ambient temperature and humidity.

### BACKGROUND OF THE INVENTION

1. Field of the Invention

The present invention relates in general to an agricultural grain dryer and, more particularly, to a grain dryer which utilizes geothermal heat to reduce drying costs and fossil fuel emissions.

2. Description of the Prior Art

Grain drying is an annual world event. Farmers must reduce the moisture content of grain prior to storage and transport. Failure to do so increases the likelihood that the grain will rot prior to use. It is well known in the art to dry grain in grain dryers which burn fossil fuels, such as natural gas. The natural gas is combusted to generate heat. The heat is transferred to air which, in turn, is provided across the grain to be dried. While fossil fuels are certainly capable of drying grain, their adaptation for such use began decades ago when natural gas was plentiful and cheap. Since that time, the cost of fossil fuels has grown enormously, reducing the efficiency of their use in drying grains.

One alternative to the use of fossil fuels in drying grain is the use of ambient air. One drawback associated with this technology is the dependency upon ambient conditions. In situations where the ambient air is cold and/or humid, the time necessary for drying the grain may exceed the window of time necessary to prevent the grain from rotting. In certain situations the ambient conditions may never allow for the grain to be sufficiently dried so as to be accepted for transport or storage. Accordingly, even in situations where ambient air is utilized to dry grain, it is often necessary to provide a fossil fuel backup system to take over when ambient conditions do not allow for proper drying.

It would, therefore, be desirable to provide an efficient grain drying system which did not rely on expensive fossil fuels as the primary source of heat. It would also be desirable to provide a drying system which was not wholly dependent upon ambient conditions for the drying of grain. It would be desirable to provide a drying system which reduced carbon emissions. It would be desirable to provide a system which provided low-cost heat and which dried the grain to the desired moisture content, regardless of ambient conditions. The difficulties encountered in the prior art discussed hereinabove are substantially eliminated by the present invention.

### SUMMARY OF THE INVENTION

In an advantage provided by this invention, a grain drying system is provided which is of a low-cost manufacture.

Advantageously, this invention provides a grain drying system which is efficient to operate and maintain.

Advantageously, this invention provides a grain drying system which is not dependent on ambient conditions for obtaining desired grain moisture content.

Advantageously, this invention provides a grain drying system which reduces the use of fossil fuels.

Advantageously, this invention provides a grain drying system which reduces carbon emissions.

Advantageously, this invention provides a grain drying system which reduces the cost of drying grains over the use of a similar system utilizing fossil fuels.

Advantageously, this invention provides a grain drying system which dries grain faster than ambient grain dryers.

In an embodiment of this invention, a grain dryer is provided, having a geothermal loop, a heat exchanger and a grain bin. The geothermal loop is provided with a conduit buried underground below the frost line. The heat exchanger transfers heat from fluid moving within the conduit to air which is transferred via a duct to the grain bin. The grain bin is provided with a plenum to evenly distribute the heated air across grain provided within the bin. The duct is provided with a telescoping portion which allows for the infusion of ambient air into the stream of heated air being provided to the grain.

### BRIEF DESCRIPTION OF THE DRAWINGS

The present invention will now be described, by way of example, with reference to the accompanying drawings in which:

FIG. 1 illustrates a side elevation in cross-section of the grain drying system of the present invention;

FIG. 2 illustrates a side elevation in partial cross-section of the grain drying system of FIG. 1, wherein the telescoping duct is open slightly to allow the infusion of ambient air;

FIG. 3 illustrates an exemplar of an equilibrium moisture chart;

FIG. 4 illustrates an alternative embodiment of the present invention utilizing a vertical geothermal loop; and

FIG. 5 illustrates an alternative embodiment of the present invention utilizing an open end lake loop.

### DETAILED DESCRIPTION OF THE PREFERRED EMBODIMENT

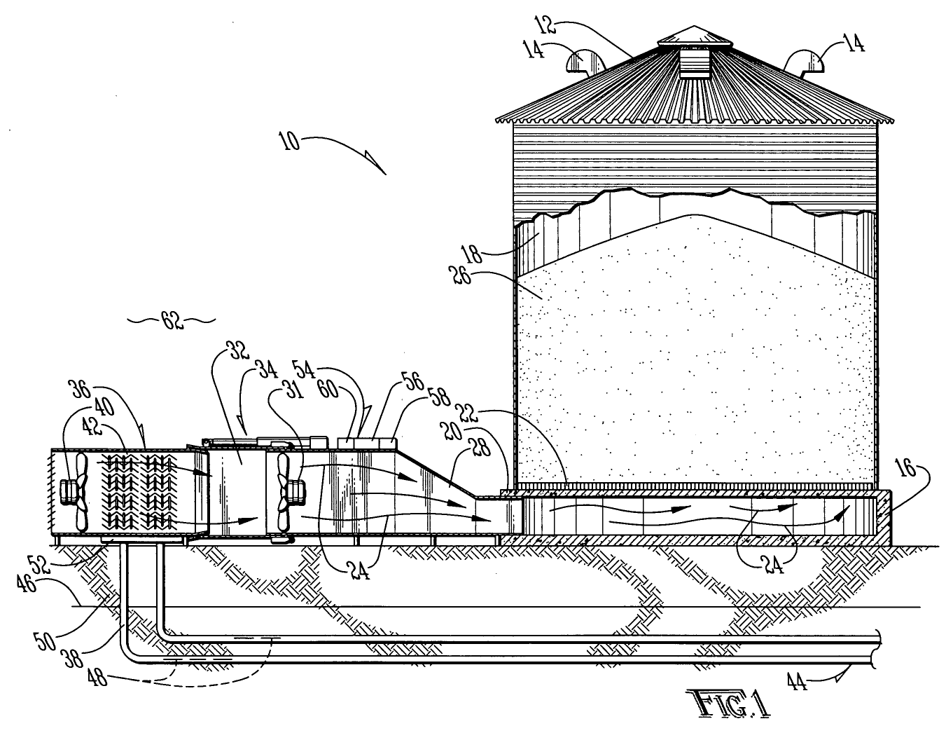

With reference to the drawings, a grain drying system according to the present invention is shown generally as (10) in FIG. 1. The system (10) includes a grain bin (12) such as those known in the art. In the preferred embodiment, the grain bin (12) has a capacity of between one hundred and one thousand cubic meters, and most preferably about five hundred thirty cubic meters. The bin (12) is provided with exhaust vents (14) such as those well known in the art.

The grain bin (12) is fitted with a plenum (16). The plenum (16) is a large open area in the bottom of the grain bin (12) separated from the top (18) of the grain bin (12) by a floor (20), provided with a plurality of perforations (22). The perforations (22) are sized to allow air (24) to pass across the floor (20), but small enough to prevent the passage of grain (26) across the floor.

As shown in FIG. 1, in the preferred embodiment, a grain such as corn, soybeans, rice or the like is provided in the grain bin (12). In the preferred embodiment, the grain (12) is provided to a depth between one and two meters, and more preferably, to a depth between one and one and one-half meters. It is preferable not to stack the grain to a height which prevents the flow of air (24) across the perforated floor (20), through the grain (26) and out the exhaust vents (14).

Coupled to the plenum (16) is a duct (28). The duct (28) may be constructed of any suitable material and any desired dimensions. In the preferred embodiment, the duct (28) is constructed of galvanized steel. The duct (28) is configured in a tube shape having a circular cross-section. As shown in FIG. 1, the duct (28) is provided with a tapered head (30) to connect with the plenum (16) of the grain bin (12). Preferably, the duct (18) is provided with a diameter of approximately one meter. Alternatively, the duct (28) may be constructed of polyvinylchloride or any other desired material.

Provided within the duct (28) is means for moving air (24) across the grain (26). In the preferred embodiment, this means is a fan (30). The fan (30) is capable of moving two hundred to one thousand cubic meters of air per minute, more preferably between four hundred and eight hundred cubic meters of air per minute and, most preferably, between five hundred and six hundred cubic meters of air per minute. The duct (28) is slidably coupled to a ring (32) which is constructed of similar material, but of a slightly larger diameter. The larger diameter allows the ring (32) to slide back and forth along the duct (28), creating a telescoping duct (34). The sliding ring (32) acts as a variable air inlet or choke. The telescoping duct (34) is coupled to a ten ton single phase electric heat pump (36), such as those known in the art. The heat pump (36) transfers heat from the heat exchange conduit (38) to the air (24). The heat pump (36) is preferably provided with a coil fan (40) which acts as a supplemental fan to move air (24) across a one square meter heat exchange coil (42) and into the telescoping duct (34). The coil fan (40) has a capacity of moving between fifty and two hundred cubic meters of air per minute, more preferably between seventy-five and one hundred fifty cubic meters of air per minute and, most preferably, about one hundred thirteen cubic meters of air per minute.

In the preferred embodiment, the heat pump (36) is operated so as to produce air (24) having a temperature of between sixty-five and one hundred degrees, and preferably eighty-five degrees. The heat exchange coil (42) is preferably coupled to the heat exchange conduit (38) which is preferably nineteen millimeters diameter rated to thirteen and six-tenths atmospheres. As shown in FIG. 1, in the preferred embodiment, the heat exchange conduit (38) is buried two meters below the ground and forms a horizontal closed loop (44). While the length of the horizontal closed loop (44) may be of any desired length, in the preferred embodiment the horizontal closed loop (44) has a length equal to two hundred fifteen meters of heat exchange conduit (38) for each ton for which the heat pump (36) is rated. Accordingly, in the present invention, with a ten ton heat pump (36) the horizontal closed loop (44) is preferably at least two thousand one hundred fifty meters in length.

As shown in the preferred embodiment, the horizontal closed loop (44) is provided below the frost line (46). The horizontal closed loop (44) is also preferably provided less than five meters deep to avoid regulatory compliance issues related to deep digging. The horizontal closed loop (44) is provided with a heat exchange fluid (48) such as propylene glycol. While any desired material may be utilized for the heat exchange fluid (48), propylene glycol is provided to reduce compliance and regulatory issues with potential leaks or other contamination issues associated with more toxic types of heat exchange fluid (48) leaching into the soil (50).

Coupled to the horizontal closed loop (44) is means for circulating fluid within the heat exchange conduit (38) which, in the preferred embodiment, is a fluid pump (52). The fluid pump (52) may be of any suitable type known in the art and moves the heat exchange fluid (48) through the horizontal closed loop (44) and into the heat pump (36). In the heat pump (36), the heat is transferred from the heat exchange fluid (42) to the air (24) which, in turn, is moved by the coil fan (40) through the heat pump (36) into the telescoping duct (34).

As shown in FIG. 1, a controller (54), provided with a hydrometer (56), thermometer (58) and central processing unit (60), is coupled to the ring (32) of the telescoping duct (34). The controller (54) is programmed to open and close the ring (32) a desired distance in response to changes in temperature and humidity. Opening and closing the ring changes the amount of ambient air (62) allowed into the telescoping duct (34) between the ring (32) and heat pump (36). If the ambient air (62) is warm and/or dry enough, allowing ambient air (62) into the telescoping duct (34) can increase the efficiency of the system (10). The controller (54) is also coupled to the fan (30) to start or increase the speed of the fan (30) when more ambient air (62) is allowed into the telescoping duct (34). The controller (54) also turns off or decreases the speed of the fan (30) when less ambient air (62) is allowed into the telescoping duct (34).

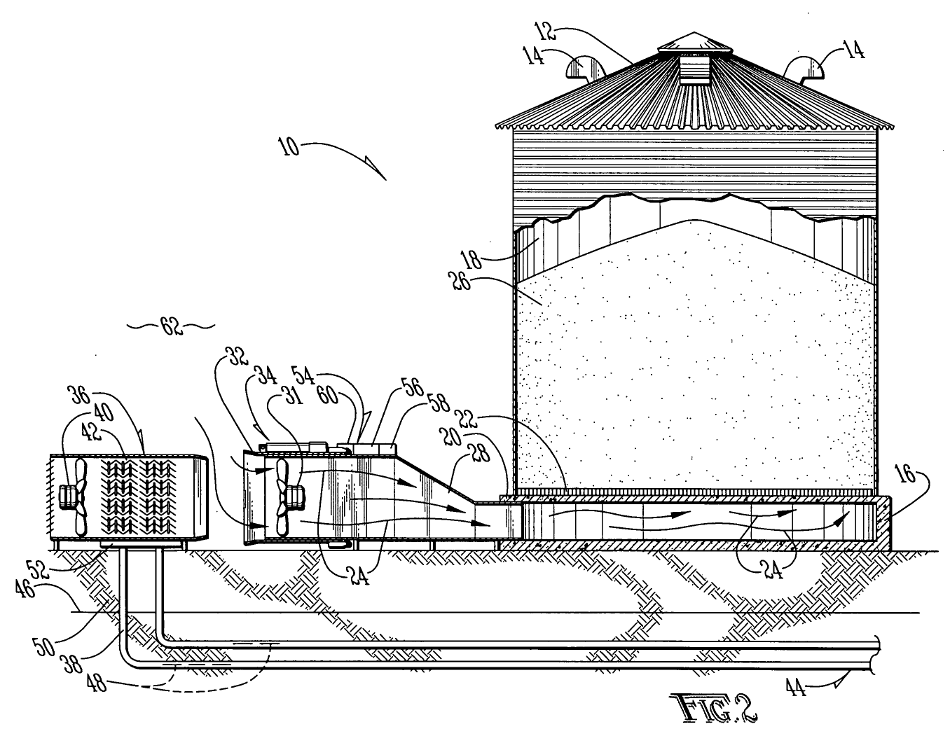

As shown in FIG. 1, when the temperature is undesirably low and/or the humidity undesirably high, the controller (54) presses the ring (32) against the heat pump (36) to completely close off and prevent the infusion of ambient air (62) into the telescoping duct (34) between the ring (32) and heat pump (36). Conversely, as shown in FIG. 2, when the ambient air (62) is relatively warm and dry, the controller (54) moves the ring (32) away from the heat pump (36) a sufficient distance to allow the infusion of ambient air (62) into the telescoping duct (34).

In situations where the ambient air (62) is too cold or humid to assist in the drying, such as is often found during nighttime, the controller (54) slows or shuts down the fan (30) so that only the coil fan (40) of the heat pump (36) is used to move air (24) across the grain (26). During the daytime, the controller (54) pulls the ring (32) back and speeds or starts the fan (30) to pull air from the heat pump, along with ambient air (62), past the fan (30) and into contact with the grain (26) provided in the grain bin (12).

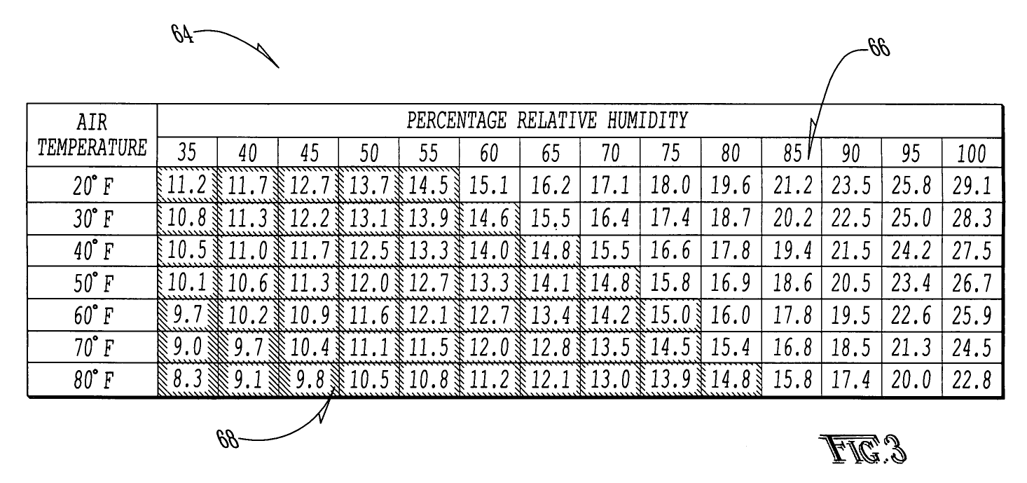

An equilibrium moisture chart is shown generally as (64) in FIG. 3. As shown, for a grain such as shelled corn the safe moisture for normal winter storage is approximately fifteen percent. In situations where the temperature is too low or the humidity is too high (66), the controller (54) is programmed to close the telescoping duct (34) and turn off the fan (30). When the ambient equilibrium moisture is favorable (68), the controller (54) is programmed to start the fan (30) and open the telescoping duct (34) in an amount equal to the favorability of the ambient equilibrium moisture. If desired, the grain drying system (10) can be operated manually with the telescoping duct (34) being closed and the fan (30) being shut off at night, and the telescoping duct (34) being opened and the fan (30) being turned on during the day.

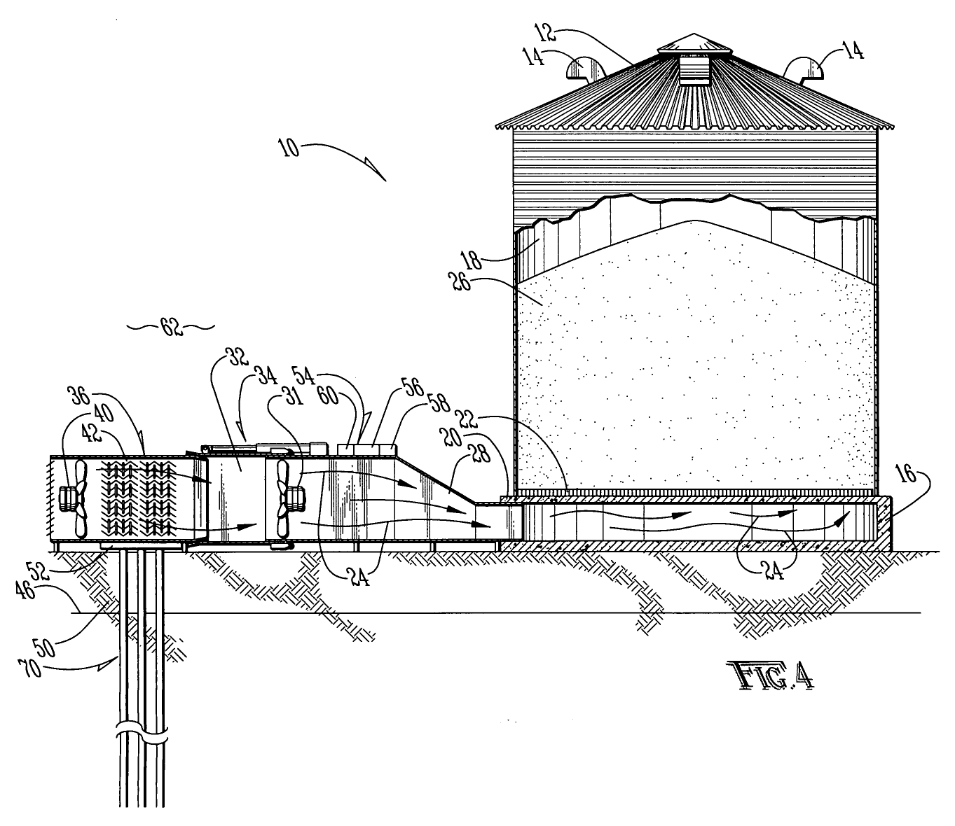

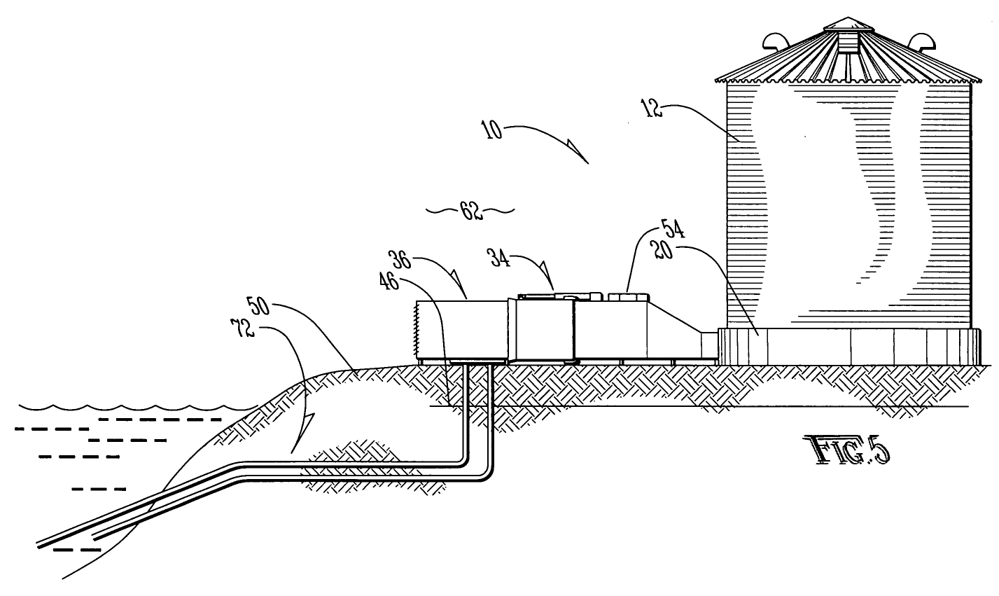

Although the invention has been described with respect to a preferred embodiment thereof, it is to be understood that it is not to be so limited since changes and modifications can be made therein which are within the full, intended scope of this invention as defined by the appended claims. For example, the geothermal loop may be a vertical closed loop (70) as shown in FIG. 4, an open end lake loop (72) as shown in FIG. 5, or a hybrid closed loop groundwater system.

What is claimed is:

1. A grain dryer comprising:
(a) a conduit provided underground;
(b) a heat exchange fluid provided within said conduit;
(c) means for circulating said fluid within said conduit;
(d) means for transferring heat from said conduit to a volume of air;
(e) a grain bin;
(f) grain provided within said grain bin; and
(g) means for moving said volume of air across said grain.

2. The grain dryer of claim 1, further comprising a plenum coupled to said grain bin.

3. The grain dryer of claim 2, further comprising a variable air inlet in fluid communication with said volume of air.

4. The grain dryer of claim 1, wherein said transferring means is a heat exchanger.

5. The grain dryer of claim 4, wherein said moving means is a fan.

6. The grain dryer of claim 5, wherein said circulating means is a fluid pump.

7. A grain dryer comprising:
(a) a heat exchange conduit provided underground;
(b) a heat exchange fluid provided within said heat exchange conduit;
(c) a fluid pump coupled to said conduit;
(d) a duct coupled to said fluid pump;
(e) a fan provided in fluid communication with said duct;
(f) a plenum coupled to said duct; and
(g) a grain bin coupled to said plenum.

8. The grain dryer of claim 7; further comprising a choke provided on said duct.

9. The grain dryer of claim 7, wherein said choke is a ring provided on said duct.

10. The grain dryer of claim 7, wherein said conduit is between one hundred and one thousand meters long.

11. The grain dryer of claim 7, further comprising grain provided within said grain bin.

12. The grain dryer of claim 7, wherein said grain bin has a capacity between one hundred and one thousand cubit meters.

13. The grain dryer of claim 7, further comprising a supplemental fan provided in fluid communication with said duct.

14. The grain dryer of claim 7, wherein said conduit is provided at least partially below the frost line.

15. A method for drying grain comprising:
(a) providing a heat exchange conduit underground;
(b) providing a heat exchange fluid within said conduit;
(c) pumping said heat exchange fluid through said conduit;
(d) transferring heat from said heat exchange conduit to air;
(e) providing a quantity of grain; and
(f) moving said air across said quantity of grain.

16. The method for drying grain of claim 15, wherein said air is between sixty-five and one hundred degrees when said air contacts said quantity of grain.

17. The method for drying grain of claim 15, further comprising providing a duct and providing said air to said quantity of grain through said duct.

18. The method for drying grain of claim 17, further comprising providing a fan within said duct and moving said air across said quantity of grain with said fan.

19. The method for drying grain of claim 18, wherein said duct is a telescoping duct.

20. The method for drying grain of claim 15, further comprising:
(a) providing a duct between said heat exchange conduit and said quantity of grain;
(b) providing said duct with a choke;
(c) providing a fan within said duct;
(d) coupling a controller to said choke;
(e) monitoring ambient temperature and humidity with said controller; and
(f) opening and closing said choke in response to changes in ambient conditions.
